(19) United States
(12) Patent Application Publication
(10) Pub. No.: US 2004/0197136 A1
(43) Pub. Date: Oct. 7, 2004

(54) Connector apparatus

(76) Inventor: Didier Thierry Emin, Fort Wayne, IN (US)

Correspondence Address: H. Duane Switzer, Jones Day, North Point, 901 Lakeside Avenue, Cleveland, OH, 44114-1190, US

(21) Appl. No.: 10/408,503

(22) Filed: Apr. 7, 2003

(51) Int. Cl. B25G 3/28

(52) U.S. Cl. 403/280

(57) ABSTRACT

A connector apparatus includes a fastener, upper and lower vibration dampers, and a retainer. Passages in the upper and lower dampers are receivable in alignment with corresponding apertures in a pair of upper and lower parts to be interconnected. The fastener has a head and a screw-threaded stem. The stem is receivable through the aligned passages and apertures to fasten the upper and lower dampers together with the upper and lower parts upon engagement of a nut on the stem. The retainer is configured to interconnect the fastener and the lower damper releasably with the upper damper in a preliminary arrangement prior to engagement of a nut on the stem.

### TECHNICAL FIELD

The invention relates to connectors that damp vibrations between interconnected parts.

### BACKGROUND

Parts that vibrate relative to each other may be fastened together by vibration dampers to reduce the transmission of vibrations between the parts. For example, a vehicle body is fastened to the vehicle frame by body mounts. The mounts comprise dampers that reduce the transmission of vibration from the vehicle suspension and frame upward to the body.

A vehicle body mount assembly typically includes upper and lower mounts, each of which has an elastomeric portion for damping vibrations. A screw-threaded fastener extends through aligned passages in the upper and lower mounts, and further through aligned apertures in the frame and body to clamp the frame, the body, and the mounts together upon tightening of a nut onto the fastener.

### SUMMARY OF THE INVENTION

In accordance with the invention, a connector apparatus includes a fastener, upper and lower vibration dampers, and a retainer. Passages in the upper and lower dampers are receivable in alignment with corresponding apertures in a pair of upper and lower parts to be interconnected. The fastener has a head and a screw-threaded stem. The stem is receivable through the aligned passages and apertures to fasten the upper and lower dampers together with the upper and lower parts upon engagement of a nut on the stem. The retainer is configured to interconnect the fastener and the lower damper releasably with the upper damper in a preliminary arrangement prior to engagement of a nut on the stem.

A distinct feature of the invention is the retainer itself. A cylindrical portion of the retainer is receivable over the fastener stem. That portion of the retainer has a pair of opposed edges that define a seam extending fully between its opposite ends. The retainer is thus expandable by spreading the opposed edges apart to widen the seam against a spring force of the cylindrical portion. This enables the retainer to grip the stem with a return spring force upon placement of the cylindrical portion over the stem.

The retainer further includes a deflectable spring tab which projects radially outward from the cylindrical portion. This enables the retainer to snap into releaseable interlocked engagement with the upper damper to suspend the fastener and the lower damper from the upper damper.

### BRIEF DESCRIPTION OF THE DRAWINGS

FIG. 1 is a side view, partly in section, of a vehicle body mount assembly;

FIG. 2 is a view of parts shown in FIG. 1;

FIG. 3 is a view of other parts shown in FIG. 1;

FIG. 4 is a view showing the parts of FIGS. 2 and 3 in interconnected positions;

FIG. 5 is a perspective view of a part shown in FIG. 1;

FIG. 6 is a sectional view of the part shown in FIG. 5; and

FIG. 7 is a cross-sectional elevational view similar to FIG. 2 and showing another embodiment.

### DESCRIPTION

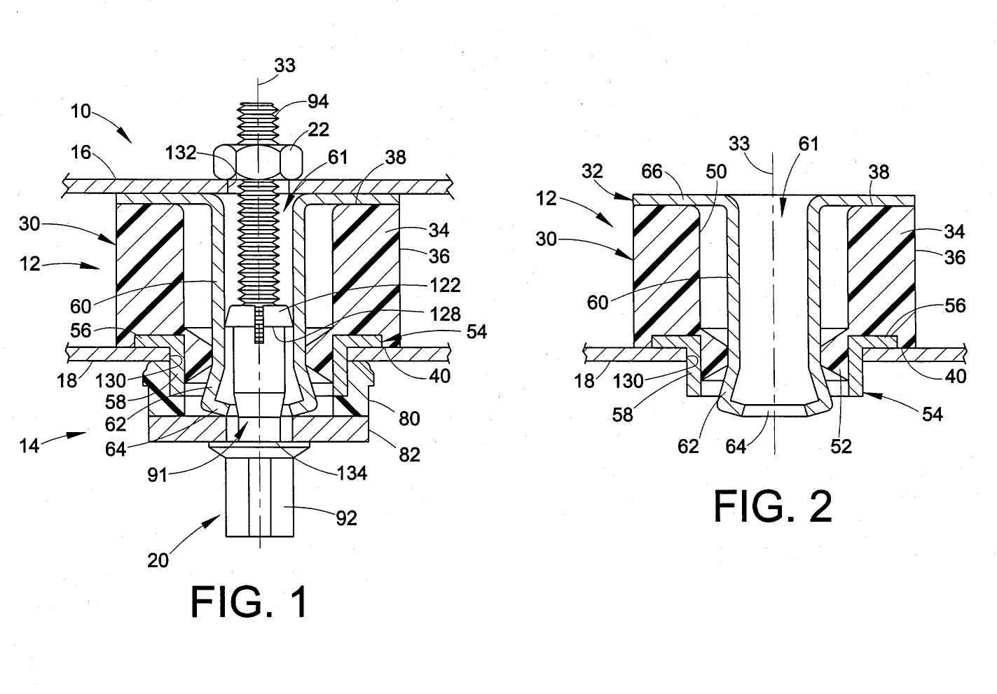

The apparatus 10 shown in FIG. 1 has parts which, as described below, are examples of the elements recited in the claims. These include upper and lower vehicle body mounts 12 and 14. The upper and lower mounts 12 and 14 support a vehicle body 16 on a vehicle frame 18 under a clamping force applied by a fastener 20 with a nut 22. Each of the mounts 12 and 14 is constructed as a vibration damper to help isolate the body 16 from vibrations of the frame 18.

As shown separately in FIG. 2.; the upper mount 12 includes an elastomeric sleeve 30 and a metal core 32. The sleeve 30 is a cylindrical part with a longitudinal central axis 33. A major section 34 of the sleeve 30 has a cylindrical outer surface 36 extending axially between a pair of annular opposite end surfaces 38 and 40. A cylindrical inner surface 50 extends fully through the sleeve 30. A tapered, ring-shaped mounting boss 52 projects radially from the inner surface 50 near the lower end of the sleeve 30.

A metal or plastic bushing 54 is molded into elastomeric sleeve 30, and has a horizontal annular flange 56 and a vertical cylindrical flange 58. The bottom or outside surface of flange 56 is flush with sleeve end surface 40, or flange 56 may extend all the way to sleeve outer surface 56. The outer surface of vertical flange 58 is dimensioned for close reception within a circular hole in frame 18.

Bushing 54 orients mount 12 relative to frame 18, restricts lateral movement, and resists abrasion of the elastomeric material due to relative movement between mount 12 and frame member 18. For some purposes, and depending on customer requirements, bushing 54 may be molded into sleeve 30 as an insert so that the outer surfaces of flanges 56 and 58 are covered by a layer of the elastomeric material.

The core 32 of the upper mount 12 includes a tube 60 which defines a passage 61 centered on the axis 33. A section 62 of the tube 60 is flared radially outward. An edge 64 of the flared section 62 is crimped radially inward at the lower end of the tube 60. A circular flange 66 projects radially outward at the upper end of the tube 60.

As further shown in FIG. 2, the elastomeric sleeve 30 is received over the metal core 32 of the upper mount 12. When the sleeve 30 is being moved axially over the core 32 toward this position, the mounting boss 52 at the inside of the sleeve 30 is stretched and snapped over the flared section 62 of the tube 60. The mounting boss 52 then grips the tube 60 concentrically so that the sleeve 30 is centered on the core 32. Flange 66 on tube 60 simply rests against upper end surface 38 on elastomeric sleeve 30, and is not bonded or otherwise secured thereto. However, for some purposes, and depending on customer requirements, upper end 38 of sleeve 30 may be adhesively bonded to the underside of flange 66, or may be secured thereto as by molding undercut generally conical or rounded projections on upper end 38 to be snapped through suitable holes in flange 66.

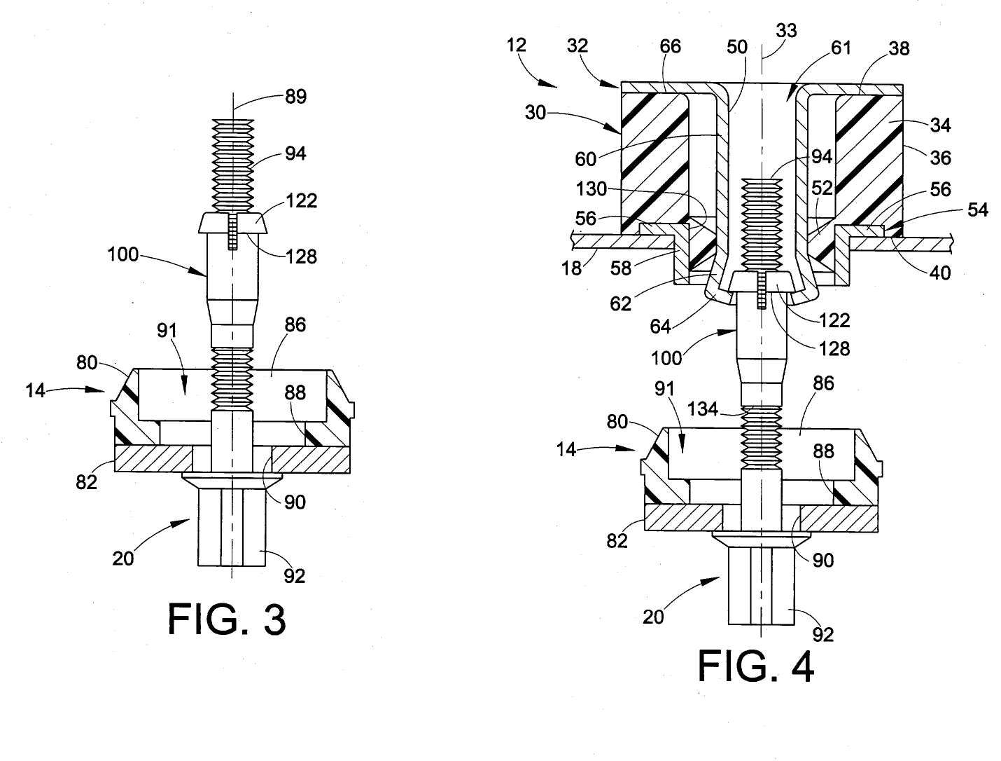

The lower mount 14 and the fastener 20 are shown together in FIG. 3. Like the upper mount 12, the lower mount 14 has an elastomeric portion 80 which is fixed to a metal portion 82. Elastomeric portion 80 and metal portion 82 may be secured together by an adhesive bond, or by a mechanical interlock such as a roughened surface on metal portion 82 or holes therein to receive and interlock with the elastomeric material during molding. The elastomeric portion 80 of the lower mount 14 is a ring-shaped part with a pair of cylindrical inner surfaces 86 and 88 centered on an axis 89.

The metal portion 82 of the lower mount 14 is a ring with a somewhat smaller inner surface 90. The three inner surfaces 86, 88 and 90 of the lower mount 14 define a passage 91 for the fastener 20, which has a head 92 and a screw-thread stem 94. The lower mount 14 rests on the head 92 of the fastener 20, with the stem 94 extending upward through the passage 91, when these parts are in the upright orientation shown in FIGS. 3 and 4.

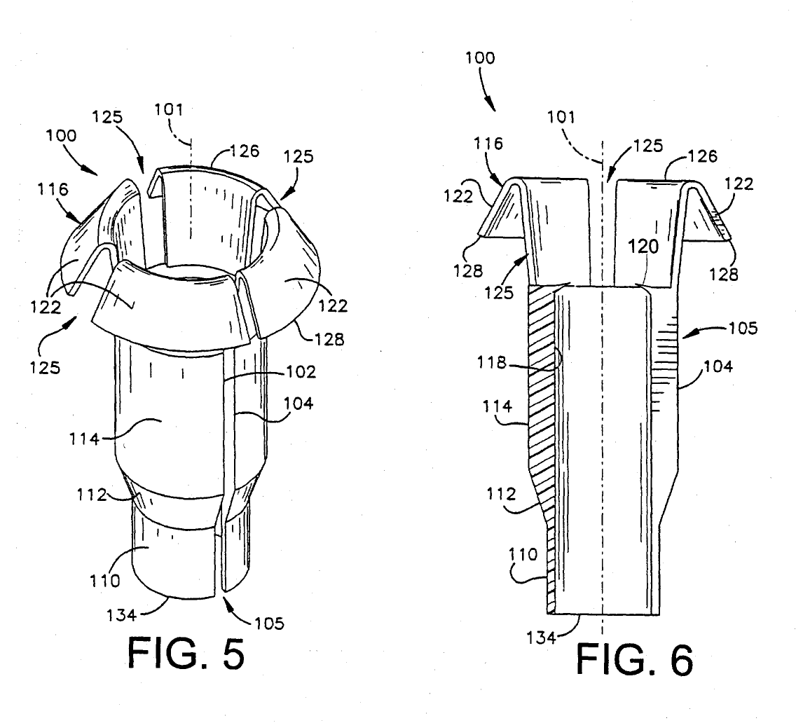

The apparatus 10 further includes a retainer 100. As shown in FIG. 5, the retainer 100 is a generally cylindrical plastic structure with a longitudinal central axis 101. A pair of opposed edges 102 and 104 of the retainer 100 define a seam 105 extending fully along its length. As best shown in FIG. 6, the retainer 100 has three distinct cylindrical sections 110, 112 and 114, with a peripheral flange structure 116 at its upper end.

The three sections 110, 112 and 114 of the retainer 100 have varying wall thicknesses, as shown in FIG. 6, but have a common cylindrical inner surface 118 with a uniform diameter. A flexible annular lip 120 projects inwardly from inner surface 118 at the upper end of retainer section 114 as shown in FIG. 6. The diameter of the inner surface 118 is less than the peak diameter of the screw thread on the fastener stem 94, and the lip 120 projects toward the root diameter of the screw thread. The retainer 100 can be expanded by spreading the opposed edges 102 and 104 apart to widen the seam 105 against a spring force of the plastic material. This enables the retainer 100 to be received over the stem 94, as shown in FIGS. 3 and 4, and also to grip the stem 94 with a return spring force that resists sliding movement of the retainer 100 along the stem 94.

The terminal end of lip 120 may lie in a single plane or may be generally helical to match the pitch of the screw thread. The lip may be continuous except for an interruption at seam 105, or may be a series of circumferentially-spaced lip portions. Similar types of lips or threads may be provided along the length of inner surface 118 to increase pull apart forces if so desired. All of such arrangements may be considered gripping projections that extend inwardly of inner surface 118 to grip the threads on the fastener 20.

The flange portion 116 of the retainer 100 includes four parts 122 on the upper section 114 that are spaced apart from each other circumferentially about the axis 101. The circumferential spacing between these parts 122 is defined by the seam 105 and by three parallel slots 125 that extend axially downward from the upper end 126 of the retainer 100. Each part 122 is folded back along its length so as to extend axially downward and radially outward from the upper end 126, and is thus configured as a radially flexible spring tab with an outer edge 128.

The parts of the apparatus 10 that are shown in FIG. 1 are interconnected with each other by first placing the upper mount 12 on the vehicle frame 18 as shown in FIG. 2. The vertical cylindrical portion 58 of bushing 54 is received closely through a circular aperture 130 in the frame 18. The annular surface 40 of the sleeve 30 and the underside of busing flange 56 overlie the frame 18 about the aperture 130. The lower mount 14, the fastener 20 and the retainer 100 are then moved upward from beneath the frame 18 and into engagement with the upper mount 12.

Specifically, the fastener stem 94 is moved upward into the passage 61 in the tube 60. The retainer 100 is carried upward into the passage 61 by the stem 94. As the retainer 100 enters the passage 61, the spring tabs 122 are cammed radially inward by the crimped lower edge 64 of the tube 60. The spring tabs 122 snap radially back outward above-the crimped lower edge 64 to block removal of the retainer 100 downward from the tube 60. The retainer 100 then suspends the fastener 20 and the lower mount 14 from the upper mount 12 in the preliminary, partially installed arrangement in which those parts are shown together in FIG. 4. The fastener 20 and the lower mount 14 are thus restrained from falling beneath the frame 18 until they can be advanced upward into the fully installed arrangement of FIG. 1.

Next, the vehicle body 16 is placed over the frame 18, with a circular aperture 132 in the body 16 centered or nearly centered over the upper mount 12. The fastener stem 94 is advanced upward through the upper mount 12 and the aperture 132 for engagement with the nut 22. The head 92 of the fastener 20 moves into abutment with the lower end 134 of the retainer 100 and pushes the retainer 100 upward from the flared section 62 into the narrower body of the tube 60. The spring tabs 122 are then lifted from the crimped lower edge 64, but continue to restrain downward movement of the fastener 20 because they are compressively engaged radially between the stem 94 and the tube 60, and also because their outer edges 128 tend to jam against the tube 60 if pulled downward.

The fastener 20 also carries the lower mount 14 upward. The cylindrical portion 58 of bushing 54 on the upper mount 12 is then received closely within the passage 91 in the lower mount 14, with the cylindrical outer surface of bushing cylindrical portion 58 adjoining the cylindrical inner surface 86. As the nut 22 is tightened onto the stem 94, it draws the fastener 20 and the lower mount 14 upward. This causes the adjoining portions of the elastomeric parts 30 and 80 to become compressively loaded and deflected axially between the frame 18 and the metal ring 82 at the bottom of the lower mount 14. The flared section 62 of the tube 60 is then received in the passage 91. The nut 22 is fully tightened when the crimped lower edge 64 of the tube 60 abuts the top side of the metal ring 82.

In addition to supporting the fastener 20 and the lower mount 14 during installation, as described above, the retainer 100 can also support the fastener 20 and the lower mount 14 in a releaseably interconnected relationship with the upper mount 12 during shipping and handling of those parts separately from the vehicle parts 16 and 18. This is because the retainer 100, when interconnected with the mounts 12, 14 and the fastener 20 in the preliminary arrangement shown in FIG. 4, will hold them together even if the upper mount 12 has not first been placed on the vehicle frame 18. The fastener 20 can be withdrawn from the retainer 100 by pulling it axially outward forcefully enough to overcome the grip of the retainer 100, but can be withdrawn more easily by pulling and rotating it counterclockwise so that the screw-thread on the stem 94 will slide against the inner surface 118 of the retainer 100 and the lip 120 or other gripping projections as though the stem 94 were being unscrewed from the retainer 100.

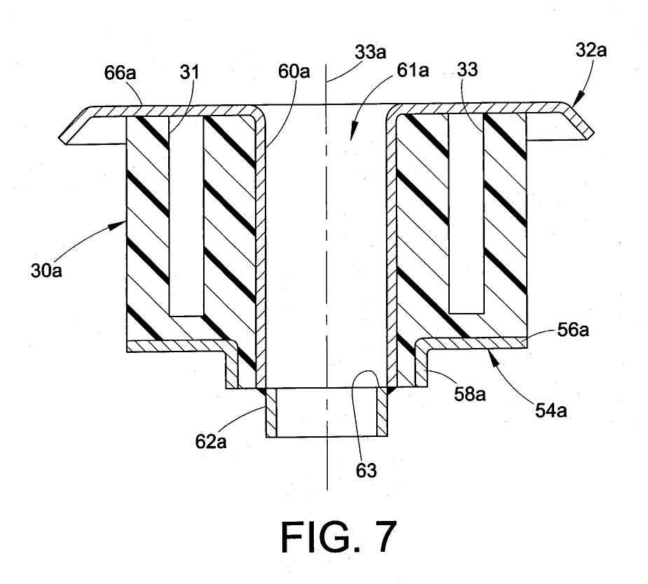

FIG. 7 shows another arrangement wherein elastomeric sleeve 30a has a plurality of axially extending bores 31, 33 circumferentially-spaced equidistantly therearound. In the arrangement shown, there were twelve bores provided. However, the number of bores and their diameter will vary with the size of the vibration damper and with customer requirements.

The bores 31, 33 provide a way to vary the spring rate of the damper. In FIG. 1, the spring rate is varied by changing the radial spacing between the inner surface 50 of the elastomeric sleeve and the outer surface of the tube 60. In general, the arrangement of FIG. 1 provides a stiffer damper than the arrangement of FIG. 7.

The other aspects of the embodiment of FIG. 7 generally correspond to the embodiment of FIG. 1. In FIG. 7, the core 32a has a cylindrical tube 60a, a flange 66a and a longitudinal axis 33a. Passage 61a in tube 60a receives the screw and retainer of FIG. 1. Bottom portion 62a of tube 60a may be a necked-in portion or may be a separate tube having a smaller diameter than tube 60a and welded thereto to provide an internal circumferential shoulder 63 against which the outer edges 128 of spring tabs 122 abut to hold the retainer within tube 60a. The bushing 54a generally corresponds in structure and function to the bushing 54 in FIGS. 1, 2 and 4.

This written description uses examples to disclose the invention, including the best mode, and also to enable a person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. An apparatus for interconnecting and damping vibrations between upper and lower parts respectively having upper and lower apertures, said apparatus comprising:
an upper vibration damper with an upper passage receivable in alignment with the apertures in the upper and lower parts;
a lower vibration damper with a lower passage receivable in alignment with the apertures in the upper and lower parts;
a fastener having a head and a screw-threaded stem receivable through said passages and the apertures in the upper and lower parts to fasten said upper and lower dampers together with the upper and lower parts upon engagement of a nut on said stem; and
a retainer configured to interconnect said fastener and said lower damper releasably with said upper damper in a preliminary arrangement prior to engagement of a nut on said stem.

2. An apparatus as defined in claim 1 wherein said lower damper rests on said head, and said stem extends upward from said head through said lower passage, through the lower aperture, and partially through said upper passage when said fastener and said lower damper are in said preliminary arrangement.

3. An apparatus as defined in claim 1 wherein said retainer is configured to be mounted on said stem and moved into engagement with said upper damper within said upper passage upon movement of said fastener into said preliminary arrangement.

4. An apparatus as defined in claim 1 wherein said retainer comprises a spring structure configured to snap into interconnected engagement with said upper damper upon movement of said fastener into said preliminary arrangement.

5. An apparatus as defined in claim 1 wherein said retainer is configured to be moved upward into said upper passage, and said retainer and said upper damper are together configured to block removal of said retainer downward from said upper passage.

6. An apparatus as defined in claim 1 wherein said retainer includes a cylindrical structure receivable over said stem, with said cylindrical structure having a pair of opposed edges defining a seam extending fully between its opposite ends, and being expandable by spreading said opposed edges apart to widen said seam against a spring force of said cylindrical structure so as to grip said stem with a return spring force upon placement of said cylindrical structure over said stem.

7. An apparatus as defined in claim 6 wherein said retainer further includes a deflectable spring tab projecting radially outward from said cylindrical structure, and said upper damper is configured for said spring tab to snap into engagement with said upper damper.

8. An apparatus as defined in claim 1 wherein said retainer includes at least one gripping projection that grips said stem.

9. The apparatus as defined in claim 8 wherein said gripping projection comprises a flexible lip.

10. An apparatus for interconnecting and damping vibrations between upper and lower parts respectively having upper and lower apertures, said apparatus comprising:
an upper vibration damper with an upper passage receivable in alignment with the upper and lower apertures;
a lower vibration damper with a lower passage receivable in alignment with the upper and lower apertures;
a fastener having a head and a stem; and
a retainer configured to suspend said fastener and said lower damper from said upper damper in an arrangement in which said lower damper rests on said head, with said stem extending upward from said head through said lower passage, through the lower aperture, and partially through said upper passage.

11. An apparatus as defined in claim 10 wherein said retainer is configured to be mounted on said stem and moved into engagement with said upper damper within said upper passage upon movement of said fastener into said arrangement.

12. An apparatus as defined in claim 10 wherein said retainer comprises a spring structure configured to snap into interconnected engagement with said upper damper and said fastener upon movement of said fastener into said arrangement.

13. An apparatus as defined in claim 10 wherein said retainer is configured to be moved upward into said upper passage, and said retainer and said upper damper are together configured to block removal of said retainer downward from said upper passage.

14. An apparatus as defined in claim 10 wherein said retainer includes a cylindrical structure receivable over said stem, with said cylindrical structure having a pair of opposed edges defining a seam extending fully between its opposite ends, and being expandable by spreading said opposed edges apart to widen said seam against a spring force of said cylindrical structure so as to grip said stem with a return spring force upon placement of said cylindrical structure over said stem.

15. An apparatus as defined in claim 14 wherein said retainer further includes a deflectable spring tab projecting radially outward from said cylindrical structure, and said upper damper is configured for said spring tab to snap into engagement with said upper damper.

16. An apparatus as defined in claim 10 wherein said retainer includes at least one gripping projection that grips said stem.

17. An apparatus as defined in claim 16 wherein said gripping projection comprises a flexible lip.

18. A vehicle body mount apparatus comprising:
an upper vehicle body mount having an upper passage;
a lower vehicle body mount having a lower passage;
a fastener having a head and a stem; and
a retainer configured to suspend said fastener and said lower mount from said upper mount in an arrangement in which said lower mount rests on said head, with said stem extending upward from said head through said lower passage and partially through said upper passage.

19. An apparatus as defined in claim 18 wherein said retainer is configured to be mounted on said stem and moved into engagement with said upper mount within said upper passage upon movement of said fastener into said arrangement.

20. An apparatus as defined in claim 18 wherein said retainer comprises a spring structure configured to snap into interconnected engagement with said upper mount and said fastener upon movement of said fastener into said arrangement.

21. An apparatus as defined in claim 18 wherein said retainer is configured to be moved upward into said upper passage, and said retainer and said upper damper are together configured to block removal of said retainer downward from said upper passage.

22. An apparatus as defined in claim 18 wherein said retainer includes a cylindrical structure receivable over said stem, with said cylindrical structure having a pair of opposed edges defining a seam extending fully between its opposite ends, and being expandable by spreading said opposed edges apart to widen said seam against a spring force of said cylindrical structure so as to grip said stem with a return spring force upon said placement of said cylindrical structure over said stem.

23. An apparatus as defined in claim 22 wherein said retainer further includes a deflectable spring tab projecting radially outward from said cylindrical structure, and said upper mount is configured for said spring tab to snap into engagement with said upper mount.

24. An apparatus as defined in claim 18 wherein said retainer includes at least one gripping projection that grips said stem.

25. An apparatus as defined in claim 24 wherein said gripping projection comprises a flexible lip.

26. An apparatus for use with a fastener having a screw-threaded stem, said apparatus comprising:
a cylindrical structure having an inner diameter that is predetermined to be less than the diameter of the screw-thread on the stem, with said cylindrical structure further having a pair of opposed edges defining a seam extending fully between its opposite ends, and being expandable by spreading said opposed edges apart to widen said seam against a spring force of said cylindrical structure so as to grip the stem with a return spring force upon placement of said cylindrical structure over the stem; and
a deflectable spring tab projecting radially outward from said cylindrical structure.

27. An apparatus as defined in claim 26 wherein said spring tab projects radially outward from an end of said cylindrical structure.

28. An apparatus as defined in claim 26 wherein said cylindrical structure includes at last one inwardly extending gripping projection that grips said stem.

29. An apparatus as defined in claim 28 wherein said gripping projection comprises a flexible lip.
